(19) United States
(12) Patent Application Publication
(10) Pub. No.: US 2010/0224848 A1
(43) Pub. Date: Sep. 9, 2010

(54) GARDEN FENCE APPARATUS AND METHOD OF CONSTRUCTING IT

(75) Inventors: Lisa R. Singer, Poway, CA (US); Steven A. Singer, Poway, CA (US)

Correspondence Address: DUCKOR SPRADLING METZGER & WYNNE;A LAW CORPORATION, 3043 4th Ave., SAN DIEGO, CA, 92103, US

(73) Assignee: Modular Merchants, Inc. dba Gardens to Gro

(21) Appl. No.: 12/551,489

(22) Filed: Aug. 31, 2009

Related U.S. Application Data
(60) Provisional application No. 61/158,487, filed on Mar. 9, 2009.

(51) Int. Cl. E04H 17/16; E04H 17/00; E04H 17/14; B23P 11/00

(52) U.S. Cl. 256/25; 256/1; 256/31; 29/428

(57) ABSTRACT

There is disclosed garden fence apparatus and a method of constructing it. The garden fence apparatus may include a garden fence assembly having a plurality of fence sections and a gate section adapted to be joined together to provide an enclosure for a protected garden area. Each fence section may include a bottom transverse support member having a plurality of openings and a plurality of rods inserted through the openings to anchor the fence section to the ground and create a barrier in the ground to prohibit creatures such as rabbits and other animals from burrowing under the fence sections and gaining access to or leaving the protected garden area. The transverse support member may also be in the form of an independent barrier strip for existing fences. The garden fence apparatus may further include an upper level enclosure fixedly fastened to the fence and gate sections to prevent or at least discourage unwanted creatures from reaching over or jumping over the fence sections into the protected area.

### RELATED APPLICATION

The application claims priority to U.S. provisional patent application No. 61/158,487, entitled GARDEN FENCE ASSEMBLY AND METHOD OF MAKING, filed Mar. 9, 2009, which is incorporated herein by reference.

### FIELD OF THE INVENTION

The present invention relates in general to a garden fence apparatus and a method of constructing it. It more particularly relates to a garden fence assembly and method useful for protecting growing plants, such as fruits and vegetables from pests including burrowing animals, such as rabbits, and taller animals, such as deer.

### BACKGROUND ART

There is no admission that the background art disclosed in this section legally constitutes prior art.

Amateur gardeners have attempted to establish and grow fruits and vegetables in a backyard setting, and have met with varying degrees of success. There have been a variety of reasons for less than desirable results.

For example, creatures such as rabbits and other animals invade the garden and eat the otherwise healthy plants. Currently, in order to keep out animals such as rabbits, gardeners build a fence around their garden areas and also dig a trench near the outer periphery of the fence. Wire or some other material is placed in the trench and covered with soil to prevent the animals from burrowing under the fence. The digging of the trench may be difficult and time consuming, especially when the soil is rocky and may not always be entirely successful in guarding the garden area.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of a garden fence apparatus in the form of an assembly constructed according to an embodiment of the invention;

FIG. 2 is an enlarged pictorial view of one of the fence sections of the garden fence assembly of FIG. 1;

FIG. 3 is a fragmentary enlarged pictorial view of the bottom rail of the fence section in FIG. 2 showing a routed channel formed in the top of the bottom support member or rail and a plurality of staples inserted therein;

FIG. 4 is an enlarged fragmentary pictorial view of the bottom rail of FIG. 3 showing one of the metal staples in the process of being inserted therein;

FIG. 5 is a fragmentary enlarged sectional view of one of the staples in the bottom rail of the fence section of FIG. 2;

FIG. 6 is a reduced-scale pictorial view of the garden fence assembly of FIG. 1, similar to FIG. 1 but illustrating the opposite side thereof having a double-door gate;

FIG. 7 is an enlarged fragmentary pictorial view of the inside of the double-door gate of FIG. 6;

FIG. 8 is an enlarged fragmentary pictorial view of a stake attached to the union of adjacent fence sections of the garden fence assembly of FIG. 1 to stabilize the assembly;

FIG. 9 is an enlarged pictorial view of a barrier threshold for the gate of the garden fence assembly of FIG. 1;

FIG. 10 is a top plan view of the threshold of FIG. 8;

FIG. 11 is an end view of the threshold of FIG. 8;

FIG. 12 is a side elevational view of the threshold of FIG. 8;

FIG. 13 is a fragmentary sectional view of a bottom rail of another embodiment of a fence section using a rod in the form of a nail;

FIG. 14 is a plan view of another embodiment of the garden fence assembly using a barrier strip along an existing fence line;

FIG. 15 is a pictorial view of another embodiment of the garden fence assembly having upper level fence and gate sections attached on top of the lower level fence and gate sections to increase the height of the garden fence assembly; and

FIG. 16 is an enlarged fragmentary detail view of attachment regions of the upper level fence and gate sections to the lower level fence and gate sections of a circled portion of FIG. 15.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

There is disclosed garden fence apparatus and a method of constructing it. One embodiment of the garden fence apparatus may include an assembly which may include a plurality of fence sections and a gate section adapted to be joined together to provide an upright enclosure for a protected area. Each fence section may include a plurality of openings, such as through holes, and a plurality of rods, such as staples, nails or other, inserted through the holes to anchor the fence section to the ground and create a barrier in the ground to help guard against creatures such as rabbits and other animals from burrowing under the fence sections and gaining access to or leaving the protected area such as a garden area for growing plants. During installation, if rocks are encountered in the ground, rods may be omitted at such locations since rocks serve as obstruction as well. The garden fence apparatus may further include an upper level enclosure fixedly fastened to the fence and gate sections to prevent unwanted creatures from reaching or jumping over the fence sections into the protected area.

In accordance with another embodiment of the present invention, there is garden fence assembly that may include a fence structure surrounding a protected area including a plurality of fence sections and a gateway permitting access to the protected area, each of the fence sections including at least one transverse bottom support member. Each of the transverse support members having a plurality of through openings and extending along the bottom portion of its fence section. A plurality of rods adapted to be inserted through the openings in the support members and depending therefrom for being driven into the ground to anchor the fence section to the ground and to create a barrier in the ground to help prevent unwanted creatures such as rabbits from burrowing under the fence sections. A swingably mounted gate closes over the gateway. The fence structure may include an arrangement of fence sections joined together at their ends

In accordance with still another embodiment of the present invention, there is provided a fence section for use in helping to provide a fence assembly for helping to surround a protected area such as a garden area. The fence section may include at least one transverse bottom support member such as a rail, and fencing material attached to the transverse support member. The transverse support member may have a plurality of openings such as through openings being spaced apart and extending along the bottom portion of the fencing material. A plurality of rods are adapted to be inserted through the openings in the support member and depend therefrom for being driven into the ground to anchor the fence section to the ground and to create a barrier in the ground to help prevent unwanted creatures from burrowing under the fence section.

In accordance with yet another embodiment of the present invention, a method of constructing a garden fence assembly may include assembling a fence structure having a plurality of fence sections, and anchoring the fence sections to the ground by driving a plurality of rods inserted through the bottom members such as rails into the ground to create a barrier in the ground to prevent creatures from burrowing under the fence sections. The fence structure may have a generally rectangular shape and define a protected area, and include a gate providing access to the protected area.

In accordance with still another embodiment of the present invention, there is provided a barrier strip to use with a fence or other barrier, or may serve as a threshold for the gateway for the garden assembly. The barrier strip may include an elongated member having a plurality of openings such as through holes and is adapted to be located on the ground adjacent to the fence or barrier or other. A plurality of rods are each adapted to be inserted through the openings in the member to depend therefrom for being driven into the ground to anchor the member to the ground and to create a barrier in the ground to prevent unwanted creatures from burrowing under the member and the fence.

In accordance with yet another embodiment of the present invention, there is a garden fence assembly that may include a fence structure for enclosing in an upright manner an area to be protected including a plurality of fence sections and having a gateway permitting access to the enclosed area. Each of the fence sections may include a lower level fence portion and an upper level fence portion to extend above the lower level fence portion to prevent or at least discourage unwanted creatures such as deer from reaching over or jumping over the fence sections into the protected area. Each fence portion may include at least one bottom transverse elongated support member and at least one top transverse elongated support member. At least one fastener may attach fixedly each of the bottom transverse support members of the upper level fence portions to the top transverse support member of the adjacent bottom level fence portions. A gate may close over the gateway and include a lower level gate portion and an upper level gate portion to extend above the lower level gate portion to further prevent or discourage the unwanted creatures from reaching over or jumping over the gate into the protected area. Each gate portion may include at least one bottom transverse elongated support member and at least one top transverse elongated support member. At least one fastener may attach fixedly the bottom transverse support member of the upper level gate portion to the top transverse support member of the adjacent bottom level gate portion. The bottom transverse support members of the lower level fence portions may include means defining a series of closely spaced openings. A group of rods may be removeably disposed in the openings to anchor the fence section to the ground and to create a barrier in the ground to prevent unwanted creatures from burrowing under the fence sections and into the protected area. The fence structure including an arrangement of fence sections joined together at their ends.

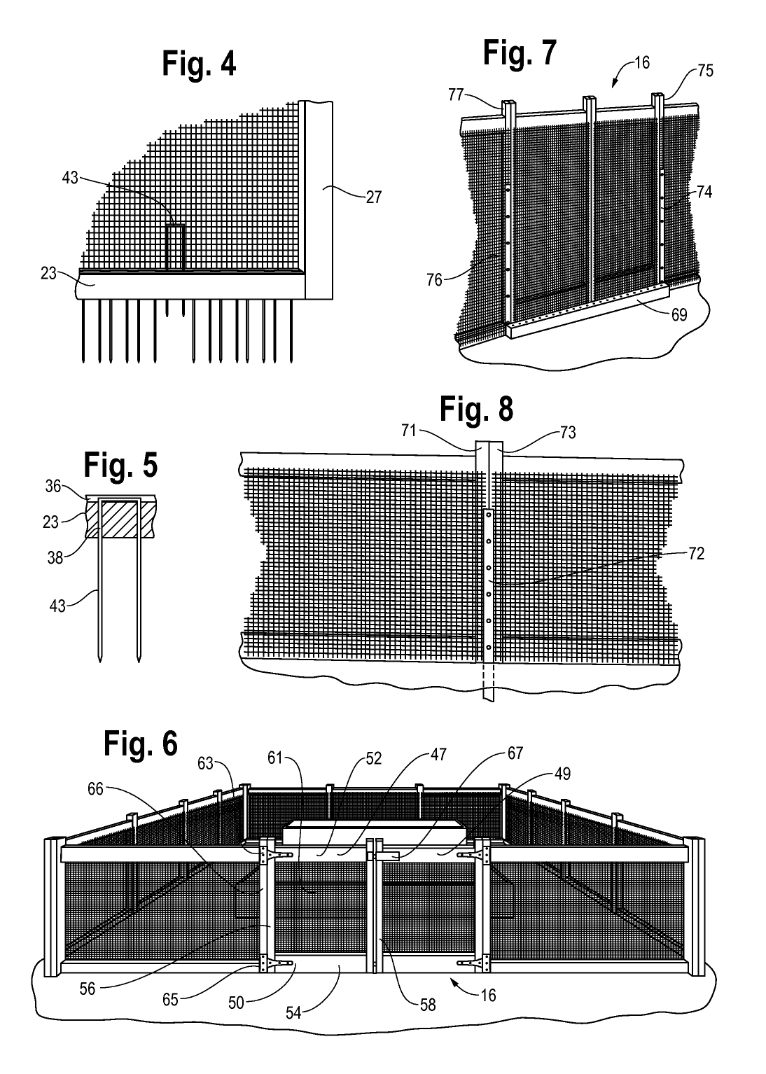

Referring now to FIGS. 1 through 7 of the drawings, there is shown a garden fence apparatus in the form of a garden fence assembly, which is constructed in accordance with an embodiment of the present invention and is generally indicated at 10. As shown in FIG. 1, the garden fence assembly 10 may include a plurality or series of fence sections, such as fence sections 12 and 14, and a double-door gate section 16 adapted to be joined together to surround and guard a protected area such as a garden area from animals or unwanted creatures and pests. The fence sections may be arranged in any desired configuration, such as a rectangle, L-shape, or other shape, to surround a garden area with a gate section used in place of at least one of the fence sections. The fence sections may be attached to the other fence sections using a plurality of fastening devices, such as screws, nails or the like. The garden area may include one or more raised garden beds 18.

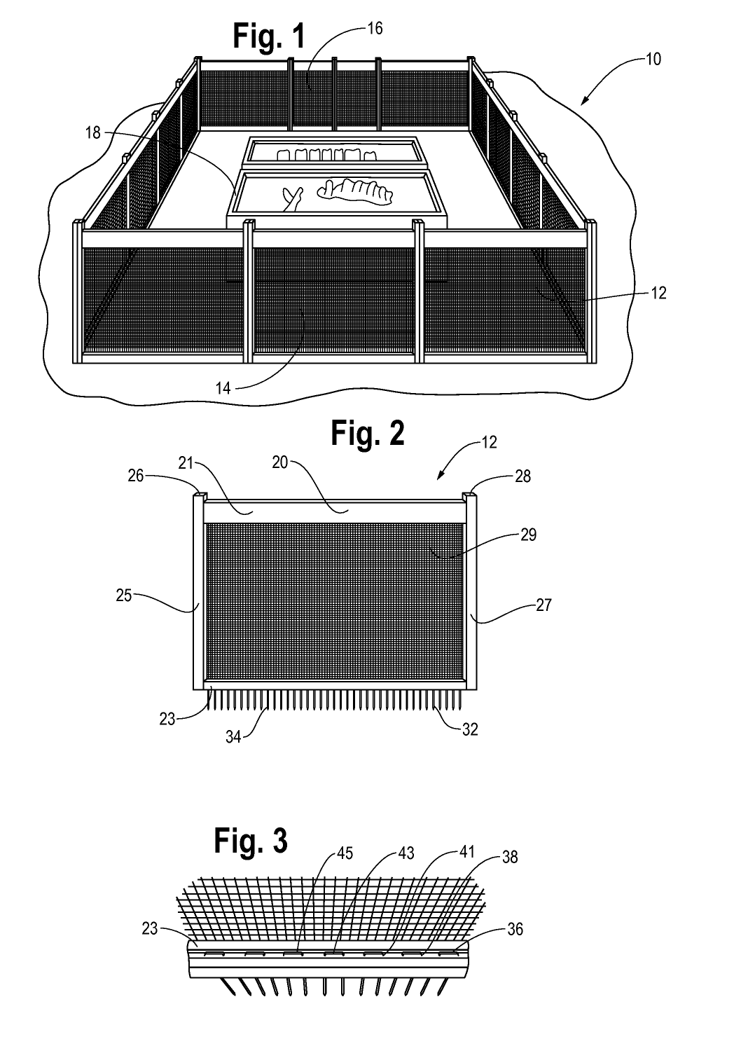

Each fence section, such as fence section 12 shown in FIG. 2, may include a frame 20 having a top rail 21, a bottom support member such as a bottom rail 23, and two side rails 25, 27 attached fixedly together in a generally rectangular or other configuration using a plurality of fastening devices, such as screws, nails or the like. The side rails 25, 27 may include top portions 26, 28, respectively, that extend above the top rail 21. The size of each fence section may be about 30 inches high by about four feet wide. Other shapes and sizes may also be employed. A fencing material 29 may be affixed to the frame. The fencing material 29 may be wire mesh, fence slats, a solid panel, or other suitable fencing material. A plurality of rods, such as rods 32, 34, may extend from the bottom of the bottom rail 23 for anchoring the fence section to the ground and creating a barrier in the ground to prevent animals from burrowing under the fence section and into the protected area.

The rods are adapted to be driven into the ground as hereinafter described in greater detail. The rods depend from the bottom rail by a sufficient distance into the ground to serve two functions. The rods serve to anchor both the rail 23 and its fence section to the ground to help support its fence section. Secondly, the rods are driven into the ground to a sufficient depth to prevent or at least prohibit or discourage unwanted burrowing pests such as rabbits and/or other creatures.

The bottom rail 23 may include a routed out channel 36 extending substantially the entire length of the top edge of the bottom rail 23 with a plurality of openings, such as spaced apart through holes 38, 41, extending from the channel 36 to the bottom edge of the rail 23, as shown in FIG. 3. The holes may be spaced between approximately 1 inch to approximately 2 inches apart, or more preferably between approximately 1.25 inches to approximately 1.75 inches apart, or most preferably approximately 1.5 inches apart. It is important to achieve a close spacing of the depending rods to achieve the desired protective barrier.

The rods may be in the form of U-shaped staples, such as staples 43, 45, which may be inserted through the holes and driven into the ground to anchor the fence section and to create a barrier of rods in the ground to prevent animals, such as rabbits or other pests, from burrowing under the fence section and entering the protected garden area as shown by staple 43 in FIG. 5. Since animals such as rabbits may typically only dig a couple of inches into the ground to get under the fence section and into the garden, the staples may well serve to prohibit or at least discourage these animals from entering into the garden area. The staples may be made of steel, plastic, composite, or other suitable rigid material and have a length of at least about six inches. The staples may also be replaced with other types of rods, such as nails, spikes or other, having similar lengths as shown by a nail 84 in FIG. 13. The tops of the staples or the heads of the nails may be at least partially concealed in the elongated routed out channel.

For certain applications and embodiments, the double-door gate section 16 may be substantially similar in size to the fence sections to permit the exchanging of locations between the sections and may include a pair of doors 47, 49 attached by hinges to the adjacent fence sections. However, other lengths of a gate section may be employed as desired. Each door, such as door 47, may include a frame 50 having a top rail 52, a bottom rail 54, and two side rails 56, 58 attached together in a generally rectangular or other configuration using a plurality of fastening devices, such as screws, nails or the like. The size of each gate section 16 may be about thirty inches high by about four feet wide. Other suitable sizes and shapes may be employed. A fencing material 61 may be affixed to the frames of the doors of the gate section 16. The fencing material 61 may be wire mesh, vinyl-coated wire mesh, fence slats, a solid panel, or other suitable fencing material.

Each door, such as the door 47, may include a pair of hinges 63, 65 for swingably attaching the door 47 to the adjacent side rail 66. The pair of hinges 63, 65 may be replaced by a piano hinge or other suitable device. Other mounting mechanisms may also be employed. A latch 67 may be attached to the doors 47, 49 to secure the doors 47, 49 in a closed position. A gate section with a single door may be used in place of the double-door gate section.

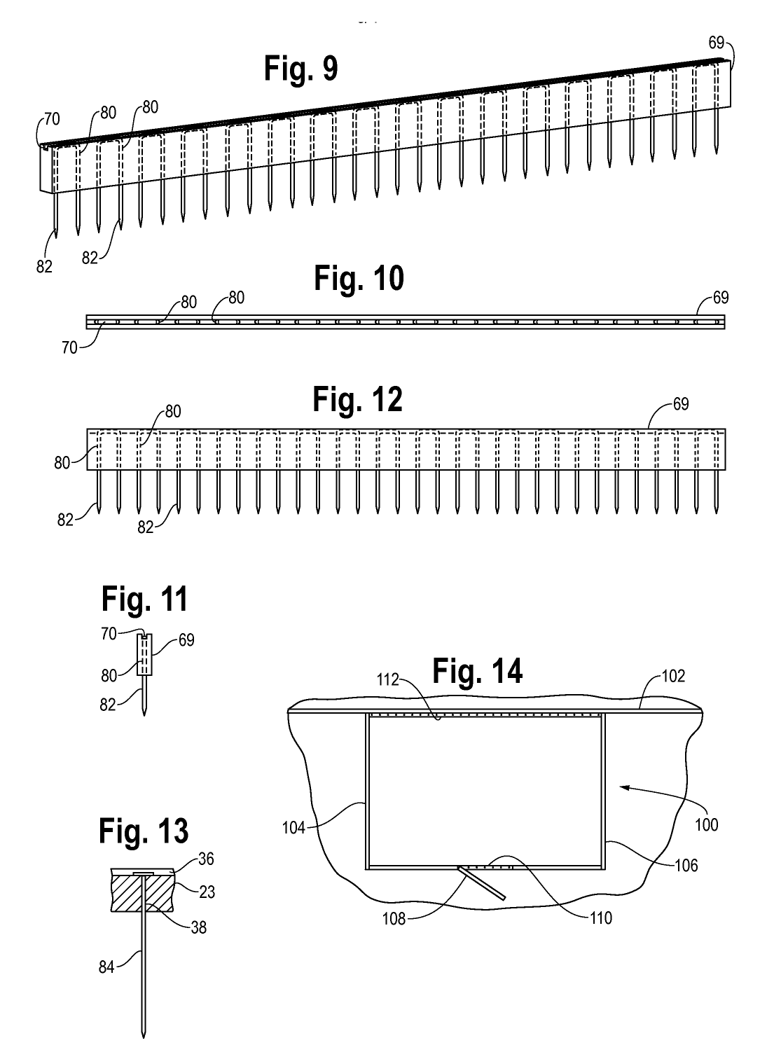

An elongated threshold 69 may be of a suitable length such as approximately four feet long. The threshold 69 may be laid horizontally on the ground opposite to the bottom of the gate section 16 and anchored to the ground in a similar manner as the fence sections, to help deter animals from digging under the gate section as shown in FIG. 7. The threshold 69 may be an elongated piece of lumber, metal, composite, or other suitable rigid or flexible material. As shown in FIGS. 9 through 12, the threshold 69 may also include a routed channel 70 and openings such as through holes 80 to receive rods such as staples 82 or nails in a manner similar to that of the bottom rail of the fence sections. By suitably adjusting the spacing between the gate section 16 and the threshold 69, the threshold 69 may also be utilized as a stop for the gate to prevent the doors of the gate from swinging into the garden area.

A plurality of rigid members such as stakes, which may be of a suitable length such as approximately three feet long, may be added to the garden fence assembly to increase the stability of the assembly in its upright disposition. The stakes, such as stake 72, may be driven approximately a foot into the ground adjacent to one or more side rails, such as side rails 71, 73, and attached using fastening devices, such as screws, nails or the like, to the one or more of the desired abutting side rails of the fence sections as shown in FIG. 8. Particularly, a pair of stakes 74, 76 may be attached to the side rails 75, 77, respectively, of the fence sections that have the doors of the gate section 16 attached thereto to provide support for the doors (FIG. 7). It should be noted that stakes such as the stake 7 may be used on both the inside and the outside of the fence section. Also, it is presently preferred to provide stakes where fence sections are longer than about 12 feet in length.

In use, the method of constructing the fence sections to create a garden fence assembly surrounding a garden area or other protected area, may include positioning the fence sections on the ground in the desired configuration, inserting staples into the holes in the bottom rails of the fence sections, driving the staples into the ground to anchor the fence sections to the ground and create a barrier to help prevent burrowing animals from entering the protected area. If one or more rocks prevent a staple from being driven into the ground, that staple may be omitted because the rocks themselves may create a convenient barrier to help discourage burrowing animals.

The U-shaped rails may be driven into the ground by any suitable tool such as a hammer, mallet or other. The tool (not shown) may be used to tap the top or bright portion of the U-shaped stable or the head of a nail or other rod. When employing the U-shaped staples, they are forceably driven into the ground until the top or bright portion enters the channel of the supporting member or rail.

A garden fence assembly may be built by preparing the required number of fence and gate sections as described above for surrounding the protected area such as a desired garden area. The appropriate number of top, bottom, and side rails may be prepared from the desired material, such as lumber, plastic, or other suitable material. A channel may be routed along the entire length of the top of each bottom rail of the fence sections with holes drilled every approximately 1.5 inches in the channel. The frames of the fence sections and of the doors of the gate section may be assembled using a plurality of fastening devices, such as screws or the like. The desired fencing material may then be affixed to these frames.

The fence sections may then be attached to one another in the desired configuration using a plurality of fastening devices, such as screws or the like, while leaving an opening for the gate section. By so doing, the fence sections and the gate section assume an upright or vertical disposition. A plurality of approximately three feet long stakes may be driven into the ground about one foot adjacent to the desired side rails of the fence sections including the two side rails adjacent to the opening for the gate section to provide stability and strength to the assembly to help maintain their upright position. These stakes may then be attached to the adjacent side rails using a plurality of fastening devices, such as screws, nails or the like. A plurality of rods such as staples or nails may then be inserted through the holes in the bottom supporting members such as bottom rails of the fence section and driven into the ground to anchor the fence sections to the ground and to create a barrier for burrowing animals. If a staple cannot be driven into the ground due to one or more rocks in the ground, the staple may be omitted in this area because the rocks may create a barrier themselves to discourage the burrowing animals.

Each door of the gate section may then be attached to the appropriate side rail of the fence section adjacent to the opening for the gate section using at least a pair of hinges, a piano hinge, or other suitable device. A latch may then be attached to the doors to allow securing the doors in a closed position. An appropriately sized piece of lumber or other suitable material may then be laid horizontally across the bottom of the gate section and anchored to the ground in a manner similar to the bottom rails of the fence sections to create a barrier to animals attempting to dig under the gate section.

The gate section can be installed at any desired position along the fence sections. For example, the gate section may be installed at a corner. Also it should be understood that a gate section may include a single door only.

Referring now to FIG. 14, another embodiment of the garden fence assembly using an existing fence line is shown. The garden fence assembly 100 may be placed adjacent to an existing fence 102 and may include a plurality of fence sections, such as fence sections 104 and 106, a gate 108, a threshold 110, and one or more barrier strips, such as the barrier strip 112. The barrier strip 112 and threshold 110 may be constructed in a manner similar to that of the threshold 69 as described above and shown in FIGS. 9 through 11. The length of the barrier strip may be of a suitable length such as between about 1 foot and about 10 feet. The barrier strip 112 may be installed adjacent to the bottom of the existing fence 102 to create a barrier to prevent or discourage creatures from burrowing under the existing fence 102 for entering or leaving the protected area.

The barrier strip 112 together with other like barrier strips (not shown) may be anchored to the ground adjacent to or near an existing fence to secure the existing fence from preventing or discouraging burrowing creatures from entering the area protected by the existing fence. The use of the inventive barrier strips for an existing fence is particularly useful where there are gaps or spacing between the bottom edge of the fence and the ground.

It is to be understood that a tall section may be included as one or more of the sections, or all of the sections can be the same height, if desired. For certain embodiments, the height of the sections may all be substantially the same, and may vary in size, by any suitable height such as between about two feet and about seven feet. The width of the sections may also vary in size, such as between about two feet and about eight feet.

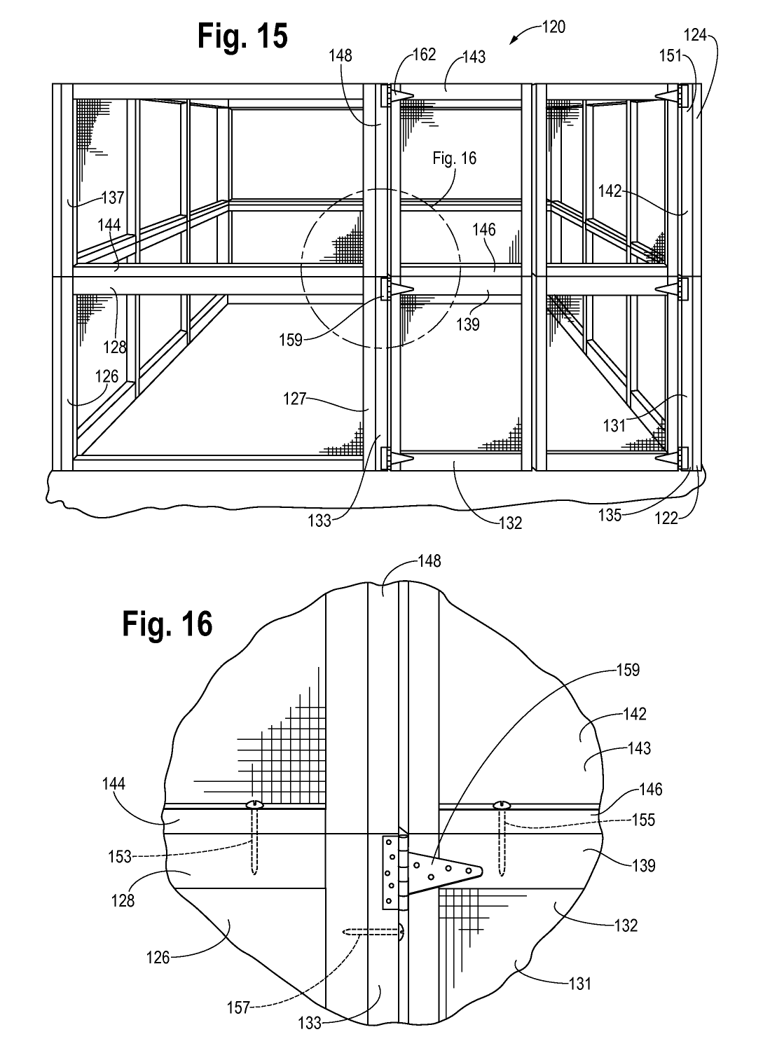

Referring now to FIGS. 15 and 16, there is shown another embodiment of the garden fence assembly 120 that creates a tall barrier to prevent unwanted creatures, such as deer, from reaching over or jumping over the garden fence assembly into the garden area. Deer and other similar animals are often able to leap over a fence to gain access to a garden to permit them to graze in an unwanted manner. The fence assembly 120 can discourage such unwanted access for certain applications, since it is designed to fence off a relatively small garden area and one which may enclose one or more raised garden beds. Since deer and other such animals prefer a clear landing area when attempting a jump, the small enclosed garden area and especially one surrounding one or more raised garden beds may discourage or prevent these animals from jumping into the garden area. However, tall animals, such as deer, may be able to reach over a fence and eat the growing vegetables and/or fruits, especially if the plants are grown in raised garden beds or have grown to a sufficient height to be eaten by an animal tall enough to reach over the fence. To help overcome both the jumping and reaching issues, the garden fence assembly 120 may include a lower level enclosure 122 and an upper level enclosure 124 fixedly attached to the lower level enclosure 122.

The lower level enclosure 122 may include a plurality of lower level fence sections, such as lower level fence sections 126, and a lower level gate section 131, and may be constructed in a similar manner to the previously described garden fence assembly 10, except that the side rails of the fence and gate sections do not include tabs, such as tabs 26 and 28 (FIG. 2), which extend above the side rails, and that the lower level gate section 131 may include additional vertical support members 133, 135.

The upper level enclosure 124 may include a plurality of upper level fence sections for being fixedly attached to the lower level fence sections, such as upper level fence sections 137 to lower level fence section 126, and an upper level gate section 142 for being fixedly attached to the lower level gate section 131. The upper level fence section 137 may be constructed in a similar manner to the previously described fence sections for the garden fence assembly 10, except that the side rails of the fence sections may not include upper portions, such as upper portions 26 and 28 (FIG. 2), which extend above the side rails, and that the bottom rails, such as bottom rail 144, may not include a routed out channel and a plurality of openings. The upper level gate section 142 may be constructed in a similar manner to the previously described gate section for the garden fence assembly 10, except that the side rails of the upper level gate section do not include upper portions, such as upper portions 26 and 28 (FIG. 2), which extend above the side rails, that the bottom rails, such as bottom rail 146, may have a height that is less than the height of the bottom rails of gate section 16 to ease attachment of the upper and lower gate sections, and that vertical support members 148, 151 may be added.

The upper level fence section 137 may be fixedly attached to the lower level fence section 126 by attaching the bottom rail 144 of the upper level fence section 137 to the top rail 128 of the lower level fence section 126 using a plurality of fasteners, such as a screw 153.

In a similar manner, the upper level gate section 142 may be fixedly attached to the lower level gate section 131 by attaching the bottom rail of each of the doors of the upper level gate section 142 to the top rail of each of the doors of the lower level gate section 131, such as the bottom rail 146 of the door 143 of the upper level gate section 142 being attached to the top rail 139 of the door 132 of the lower level gate section 131 using a plurality of fasteners, such as a fastener 155. The vertical supports of the gate sections 131, 142 may be fixedly attached to the side rails of the adjacent fence sections, such as the vertical support 133 of the lower level gate section 131 being attached to the side rail 127 of the lower level side fence section 126 using a plurality of fasteners, such as a screw 157.

Each of the doors of the lower level gate section 131 may be attached either directly or via one of the vertical supports to the side rail of the adjacent lower level fence section using a pair of hinges, such as a hinge 159 attaching the door 132 to the vertical support 133 attached to the side rail 127 of the lower level fence section 126. When the upper level gate section 142 is attached to the lower level gate section 131, each of the doors of the upper level gate section 142 may be attached either directly or via one of the vertical supports to the side rail of the adjacent upper level fence section using a single hinge, such as a hinge 162 attaching the door 143 to the vertical support 148 attached to the side rail 138 of the upper fence section 137. The vertical supports of the upper and lower level gate sections may provide additional stability to the garden fence assembly and may allow the doors to be pre-hung to simplify installation.

Due to the design of the upper and lower level enclosures, manufacturing may be accomplished very efficiently. The design of the upper and lower level fence sections may be similar and even substantially identical, except that the bottom rails of the upper level fences may not include the channel and/or the plurality of openings for the rods. Likewise, the design of the upper and lower level gate sections may be similar and even substantially identical, except that the bottom rails of the upper level gate sections may be shorter in height than the bottom rails of the lower level gate section to ease attachment with the top rail of the lower level gate section.

Words such as “about,” “approximately” or other such words as used herein shall be defined to mean a tolerance of plus or minus 20 percent.

While particular embodiments of the present invention have been disclosed, it is to be understood that various different modifications are passing and one contemplated within the true spirit and scope of the appended claims. For example, fence and/or gate sections could be composed of a variety of materials, such as wood, plastic, metal and other, and they can be dimensioned to a standard length such as about four feet long for convenient packaging as a kit, or about 8 feet long to be sold as a commodity item. Also, it will become apparent that a variety of different types and kinds of fastening devices may be employed, including, but not limited to, screws, nails, nuts and bolts, rivets, brackets, adhesives and others. There is no intention, therefore, of limitations to the exact abstract or disclosure herein presented.

What is claimed is:

1. A garden fence assembly, comprising:
a fence structure for enclosing in an upright manner an area to be protected including a plurality of fence sections and having a gateway permitting access to the enclosed area;
each of the fence sections including at least one bottom transverse elongated support member;
each of the transverse support members extending along the bottom portion of its fence section and having a plurality of openings;
a plurality of rods adapted to be inserted through the openings in the support members and depending therefrom for being driven into the ground to anchor the fence section to the ground and to create a barrier in the ground to prevent unwanted creatures from burrowing under the fence sections and into the protected area;
wherein rods may be omitted where obstructions in the ground prevent rods from being conveniently driven into the ground;
a gate for closing over the gateway; and
the fence structure including an arrangement of fence sections joined together at their ends.

2. The garden fence assembly according to claim 1, further including a threshold for resting on the ground substantially spanning the gateway generally opposite to the bottom of the gate when closed.

3. The garden fence assembly according to claim 2, wherein the threshold is adapted to be anchored to the ground.

4. The garden fence assembly according to claim 3, wherein the threshold includes a plurality of openings with a plurality of rods inserted through the openings to anchor the threshold to the ground and create a barrier in the ground to prevent creatures from burrowing under the threshold and into the protected area.

5. The garden fence assembly according to claim 1, wherein the gate includes a pair of doors.

6. The garden fence assembly according to claim 1, wherein the rods are generally U-shaped staples.

7. The garden fence assembly according to claim 1, wherein each rod has a length of at least about six inches.

8. The garden fence assembly according to claim 1, wherein the rods are nails.

9. The garden fence assembly according to claim 1, wherein each support member and the threshold includes a channel routed substantially the entire length thereof.

10. The garden fence assembly according to claim 1, further including at least one elongated stake attached to a side rail of one of the fence sections and driven into the ground to increase the stability of the structure.

11. The garden fence assembly according to claim 1, wherein the width of the fence section is substantially equal to the width of the gate.

12. The garden fence assembly according to claim 1, wherein the width of the fence section is approximately four feet.

13. A method of constructing a garden fence assembly, comprising:
assembling a fence structure along the periphery of an area to be protected, the fence structure including a gate providing access to the protected area and a plurality of fence sections; and
anchoring the fence sections to the ground by driving a plurality of rods inserted through the bottom rails of the fence sections into the ground to create a barrier in the ground to prevent creatures from burrowing under the fence sections and into the protected area.

14. The method of constructing a garden fence assembly according to claim 13, further including:
driving a stake into the ground adjacent to a side rail of one of the fence sections; and
attaching the stake to the side rail to increase stability of the fence structure.

15. The method of constructing a garden fence assembly according to claim 13, further including anchoring a threshold into the ground extending substantially opposite to the bottom of the gate when closed.

16. The method of constructing a garden fence assembly according to claim 13, wherein:
placing a threshold on the ground substantially adjacent to the bottom of the gate, and
the anchoring of the threshold to the ground includes driving a plurality of rods through the threshold into the ground to create a barrier in the ground to prevent creatures from burrowing under the threshold and into the protected area.

17. The method of constructing a garden fence assembly according to claim 13, wherein the rods are U-shaped staples.

18. The method of constructing a garden fence assembly according to claim 13, wherein each rod has a length of at least six inches.

19. The method of constructing a garden fence assembly according to claim 13, wherein the rods are nails.

20. A barrier strip for an upright fence, comprising:
an elongated member having a plurality of openings and adapted to be located on the ground adjacent to the fence for help guarding a protected area; and
a plurality of rods adapted to be inserted through the openings in the member and depending from the member for being driven into the ground to anchor the member to the ground and to create a barrier in the ground to prevent unwanted creatures from burrowing under the member and the fence and into the protected area.

21. The barrier strip according to claim 20, wherein the rod is a staple.

22. The barrier strip according to claim 20, wherein each rod has a length of at least six inches.

23. The barrier strip according to claim 20, wherein each one of the rods is a nail.

24. A fence section for guarding a protected area, comprising:
at least one transverse bottom support member;
the transverse support member having a plurality of spaced-apart openings extending therethrough and extending along the bottom portion of the fence section; and
a plurality of rods adapted to be inserted through the openings in the support member to depend therefrom for being driven into the ground to anchor the fence section to the ground and to create a barrier in the ground to prevent unwanted creatures from burrowing under the fence section and into the protected area.

25. A garden fence assembly, comprising:
a fence structure for enclosing in an upright manner an area to be protected including a plurality of fence sections and having a gateway permitting access to the enclosed area;
each of the fence sections including a lower level fence portion and an upper level fence portion to extend above the lower level fence portion to prevent or discourage unwanted creatures from reaching over or jumping over the fence sections into the protected area;
each fence portion including at least one bottom transverse elongated support member and at least one top transverse elongated support member;
at least one fastener for attaching fixedly each of the bottom transverse support members of the upper level fence portions to the top transverse support member of the adjacent bottom level fence portions;
a gate for closing over the gateway;
the gate including a lower level gate portion and an upper level gate portion to extend above the lower level gate portion to prevent or discourage unwanted creatures from reaching over or jumping over the gate into the protected area;
each gate portion including at least one bottom transverse elongated support member and at least one top transverse elongated support member;
at least one fastener for attaching fixedly the bottom transverse support member of the upper level gate portion to the top transverse support member of the adjacent bottom level gate portion;
the bottom transverse support members of the lower level fence portions including means defining a series of closely spaced openings;
a group of rods for being removeably disposed in the openings to anchor the fence section to the ground and to create a barrier in the ground to prevent unwanted creatures from burrowing under the fence sections and into the protected area; and
the fence structure including an arrangement of fence sections joined together at their ends.

26. The garden fence assembly according to claim 25, further including a threshold for resting on the ground substantially spanning the gateway generally opposite to the bottom of the gate when closed.

27. The garden fence assembly according to claim 26, wherein the threshold includes a plurality of openings with a plurality of rods inserted through the openings to anchor the threshold to the ground and create a barrier in the ground to prevent creatures from burrowing under the threshold and into the protected area.

28. The garden fence assembly according to claim 25, wherein the gate includes a pair of doors.

29. The garden fence assembly according to claim 25, wherein the rods are generally U-shaped staples.

30. The garden fence assembly according to claim 25, wherein each rod has a length of at least about six inches.

31. The garden fence assembly according to claim 25, further including at least one elongated stake attached to a side rail of one of the fence sections and driven into the ground to increase the stability of the structure.

32. The garden fence assembly according to claim 1, wherein the width of the fence section is substantially equal to the width of the gate.

33. The garden fence assembly according to claim 1, wherein the width of the fence section is approximately four feet.

34. A garden fence assembly, comprising:
a fence structure for enclosing in an upright manner an area to be protected including a plurality of fence sections and having a gateway permitting access to the enclosed area;
each of the fence sections including a lower level fence portion and an upper level fence portion to extend above the lower level fence portion to prevent or discourage unwanted creatures from reaching over or jumping over the fence sections into the protected area;
each fence portion including at least one bottom transverse elongated support member and at least one top transverse elongated support member;
at least one fastener for attaching fixedly each of the bottom transverse support members of the upper level fence portions to the top transverse support member of the adjacent bottom level fence portions;
a gate for closing over the gateway;
the gate including a lower level gate portion and an upper level gate portion to extend above the lower level gate portion to prevent or discourage unwanted creatures from reaching over or jumping over the gate into the protected area;
each gate portion including at least one bottom transverse elongated support member and at least one top transverse elongated support member;
at least one fastener for attaching fixedly the bottom transverse support member of the upper level gate portion to the top transverse support member of the adjacent bottom level gate portion; and
the fence structure including an arrangement of fence sections joined together at their ends.
